(19) United States
(12) Patent Application Publication
(10) Pub. No.: US 2003/0191889 A1
(43) Pub. Date: Oct. 9, 2003

(54) Method and apparatus for managing operation of a storage device based on operating temperatures in the storage device

(75) Inventor: Thomas R. Forrer JR., Round Rock, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/116,639

(22) Filed: Apr. 4, 2002

(51) Int. Cl. G06F 12/00

(52) U.S. Cl. 711/112

(57) ABSTRACT

A method, apparatus and computer instructions for managing a storage device. An operating temperature is monitored in the storage device. Responsive to the operating temperature exceeding a threshold temperature, operation of the storage device is altered to reduce effects of the storage device operating when the operating temperature exceeds the threshold temperature.

### BACKGROUND OF THE INVENTION

1. Technical Field

The present invention relates generally to an improved data processing system, and in particular, to a method and apparatus for managing operation of a storage device. Still more particularly, the present invention provides a method and apparatus for managing operation of a storage device based on operating temperatures within the storage device.

2. Description of Related Art

The use of computers and other types of data processing systems have become widespread. A data processing system is a general-purpose machine, such as a personal computer or a personal digital assistant, that processes data according to a set of instructions that are stored internally either temporarily or permanently. The instructions that tell it what to do are called “software.” A set of instructions that perform a particular task is called a “program” or “software program.” The instructions in the program direct the data processing system to input, process and output data. A data processing system can selectively retrieve data into its main memory from any peripheral device, such as a terminal, disk, or tape. After processing the data, the data processing system can send a copy of the results from its memory out to any peripheral device. The more memory it has, the more programs and data it can work with at the same time. Typically, data is stored on a storage device such as a magnetic disk or tape to permanently store the data for later retrieval. With respect to storage of data for a data processing system, the semi-permanent or permanent holding place for digital data includes devices, such as disks and tapes. Magnetic disks, such as hard disk drives or floppy disks, hold magnetically recorded data. These disks can be re-recorded over and over.

Magnetic tape drives use magnetic tape as a sequential storage medium. This type of storage is typically used for data collection, backup and historical purposes. Magnetic tape is made of flexible plastic with one side coated with a ferromagnetic material. Tapes come in reels and cartridges of many sizes and shapes. Although still used in legacy systems, open reels have been mostly superseded by cartridges with enhanced storage capacities.

Optical disk drives use a direct access disk, which is written and read by light. A digital versatile disc (DVD) and a compact disc (CD) are examples of optical disks used in optical disk drives. Many types of optical disks are available. CD, CD-ROM, DVD-ROM and DVD-Video are examples of read-only optical disks that are recorded at the time of manufacture and cannot be erased. CD-R, DVD-R, WORM, and magneto-optic (in WORM mode) disks are examples of write-once optical media. These types of disks are recorded in the user's environment, but cannot be erased. CD-RW, DVD-RAM, DVD−RW, DVD+RW and MO disks are examples of rewritable optical media.

These types of storage devices generate heat during operation. These devices are designed to operate within certain temperature ranges. When the temperature ranges are exceeded for a particular device, the device may fail or operate incorrectly. Further, operation of a storage device above a recommended or specified operating temperature may not cause the drive to fail immediately, but result in a long-term reliability problem. Therefore, it would be advantageous to have an improved method, apparatus, and computer instructions for managing operation of storage devices based on operating temperatures in the devices.

### SUMMARY OF THE INVENTION

The present invention provides a method, apparatus and computer instructions for managing a storage device. An operating temperature is monitored in the storage device. Responsive to the operating temperature exceeding a threshold temperature, operation of the storage device is altered to reduce effects of the storage device operating when the operating temperature exceeds the threshold temperature.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system is shown in which the present invention may be implemented;

FIG. 3 is a diagram of a storage device in accordance with a preferred embodiment of the present invention; and

FIG. 4 is a flowchart of a process used to control the operation of a storage device in accordance with a preferred embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with computer 100, such as, for example, a joystick, touchpad, touch screen, trackball, microphone, and the like.

Computer 100 can be implemented using any suitable computer, such as an IBM RS/6000 computer or IntelliStation computer, which are products of International Business Machines Corporation (IBM), located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

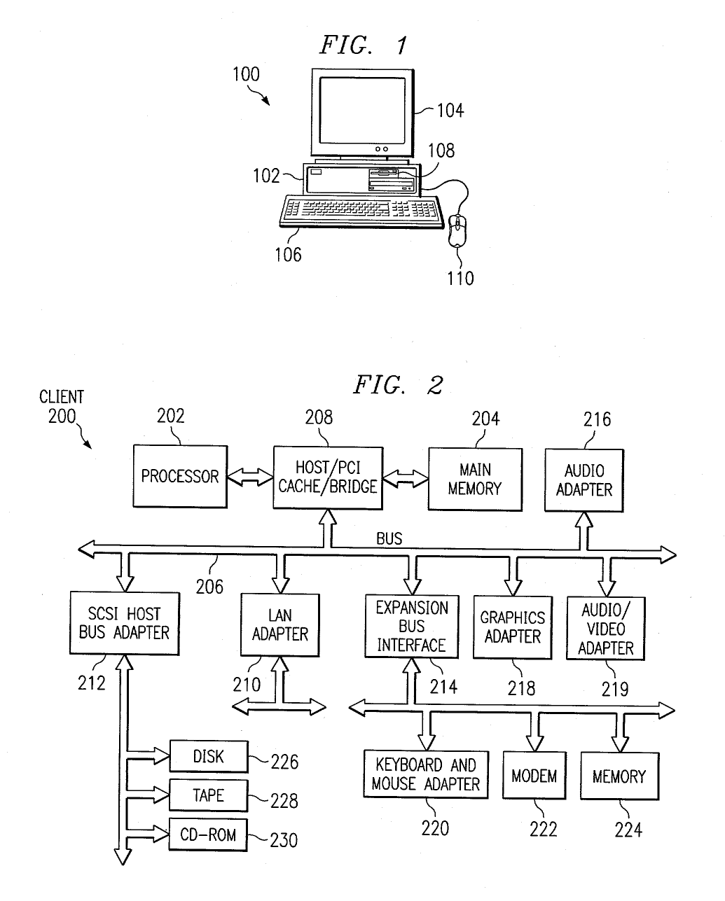

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection.

In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors. In particular, the mechanism of the present invention may be implemented to control the operation of storage devices, such as disk 226, tape 228, and CD ROM 230 based on the operating temperatures in these devices. The operation of these devices may be altered to protect the devices when a temperature within the device exceeds one or more predefined threshold temperatures.

An operating system runs on processor 202 and is used to coordinate and provide control of various components within data processing system 200 in FIG. 2. The operating system may be a commercially available operating system such as Windows 2000, which is available from Microsoft Corporation. Instructions for the operating system and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

The present invention provides a method, apparatus, and computer instructions that may be used to protect a drive from failure or long-term degradation when operating temperatures exceeding those recommended for the devices occur. Currently, many storage devices include temperatures sensors incorporated within the device used to monitor the temperature of the device. If the temperature exceeds certain limits, the storage device notifies the data processing system that the storage device is operating under conditions that may cause it to fail. The mechanism of the present invention extends the use of this temperature sensor to allow the storage device to take actions to protect itself whenever the temperature within the storage device measured by the sensor exceeds one or more predefined thresholds.

For example, a first temperature threshold may be set based on the reliability degradation characteristics of the storage device. The temperature is chosen based upon the fact that the devices long term failure rate may be degraded minimally if the drive is operated over the short term. This time period may be as short as hours or a few days at most. The particular temperature used for the threshold is based on operating temperatures for the particular storage device and may include other factors, such as, for example, degradation characteristics of the storage device.

When this threshold temperature is exceeded, the storage device reduces its power consumption by limiting the actuator power consumption by having it perform fewer accesses to the storage media. During this time the storage device will report recoverable error sensor data for media access commands that contain a thermal warning as additional sensor data. For example, in a hard disk drive, a small computer system interface (SCSI) self monitoring analysis and reporting technology (S.M.A.R.T) function can be used to report this type of error.

If the drives temperature sensor continues to detect increasing temperature changes to the point where a second temperature threshold is reached, the storage device shuts off any motors that may be used to manipulate the storage media. For example, in a hard disk drive, the spindle motor is shut off and the drive then goes into sleep mode. In this mode the drive remains active on the host system bus but returns a status indicating the drive cannot access data until the temperature is reduced. While the drive is in this mode, the drive is able to withstand much higher temperatures without becoming damaged to the point where the drive will permanently fail. This situation occurs because no mechanical motion is occurring and most of the drive electronic components are powered down. Example threshold temperatures may be, for example, a first threshold temperature of about 65° C. and the second threshold temperature of about 85° C.

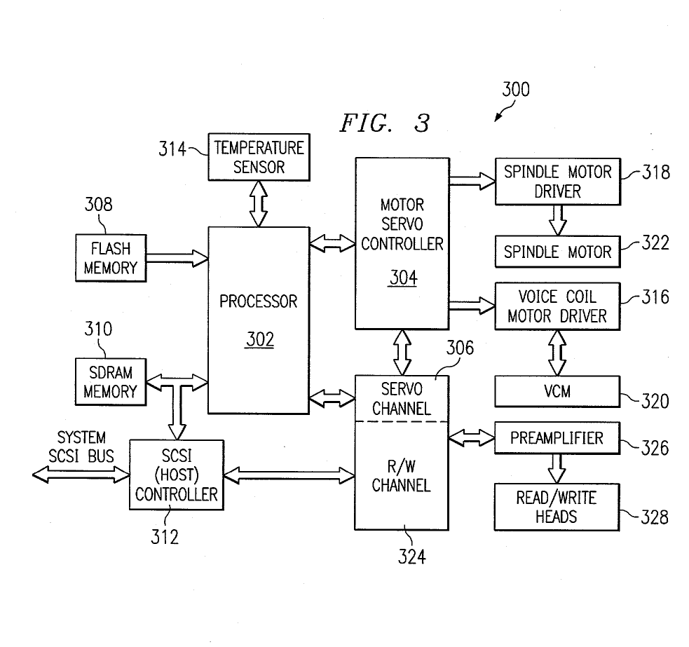

Turning next to FIG. 3, a diagram of a storage device is depicted in accordance with a preferred embodiment of the present invention. In this example, storage device 300 is a hard disk drive, such as disk 226 in FIG. 1. Specifically, storage device 300 may be implemented using an Ultrastar 73 LZX hard disk drive, which is available from IBM. This hard disk drive may be modified to include the functionality and processes of the present invention with respect to controlling the operation of storage device 300 based on temperatures detected within the storage device.

Storage device 300 includes a processor 302 connected to motor servo controller 304, servo channel 306, flash memory 308, synchronous dynamic random access memory (SDRAM) 310, SCSI controller 312, and temperature sensor 314. Motor servo controller 304 is connected to servo channel 306, voice coil motor (VCM) driver 316, and spindle motor driver 318. Voice coil motor driver 316 is connected to voice coil motor 320, and spindle motor driver 318 is connected to spindle motor 322. Servo channel 306 is connected to read/write (R/W) channel 324, which in turn has a connection to SCSI controller 312 as well as preamplifier 326. In turn, preamplifier 326 is connected to read/write heads 328. SCSI controller 312 provides a connection to a SCSI bus, which may have other peripherals connected to the SCSI bus.

Processor 302 controls the operation of storage device 300. Instructions for processor 302 are obtained from flash memory 308. These instructions may include, for example, boot microcode for processor 302 and instructions for controlling the operation of storage device 300 based on temperatures within storage device 300. SDRAM 310 serves as a data cache as well as holding microcode for processor 302. SCSI controller 312 provides a host interface to the computer system for storage device 300.

R/W channel 324 serves to demodulate data from preamplifier 326 to create servo information for servo channel 306 to control the position of read/write heads 328. Preamplifier 326 amplifies low level signals received from read heads within read/write heads 328 and provides drive currents to write heads within read/write heads 328. Further, preamplifier 326 is used to select the appropriate head within read/write heads 328 for a read or write function.

Motor servo controller 304 creates analog signals to control the speed of spindle motor 322 and to control voice coil motor 320 through spindle motor driver 318 and voice coil motor driver 316, respectively. Spindle motor 322 spins to manipulate the storage media in storage device 300 while voice coil motor 320 moves to control the position of read/write heads 328 with respect to the storage media.

Temperature sensor 314 is used to obtain temperature data within storage device 300. Although a single sensor is illustrated here, more than one additional sensor may be used depending on the particular implementation. Based on the temperature data received from temperature sensor 314, processor 302 may alter the operation of storage device 300 if the temperatures exceed or reach selected thresholds. For example, processor 302 may reduce the rate of access to storage media if the temperature exceeds a selected threshold temperature. Additionally, processor 302 may shut down a motor, such as spindle motor 322, if the temperature data indicates that the temperature has exceeded a different threshold temperature.

Although storage device 300 is a hard disk drive in this example, the mechanism of the present invention may be applied to other types of storage devices. The mechanism may be used in any storage device in which temperature may affect the reliability of the storage device. For example, the mechanism of the present invention also may be used in a tape drive or an optical disc drive.

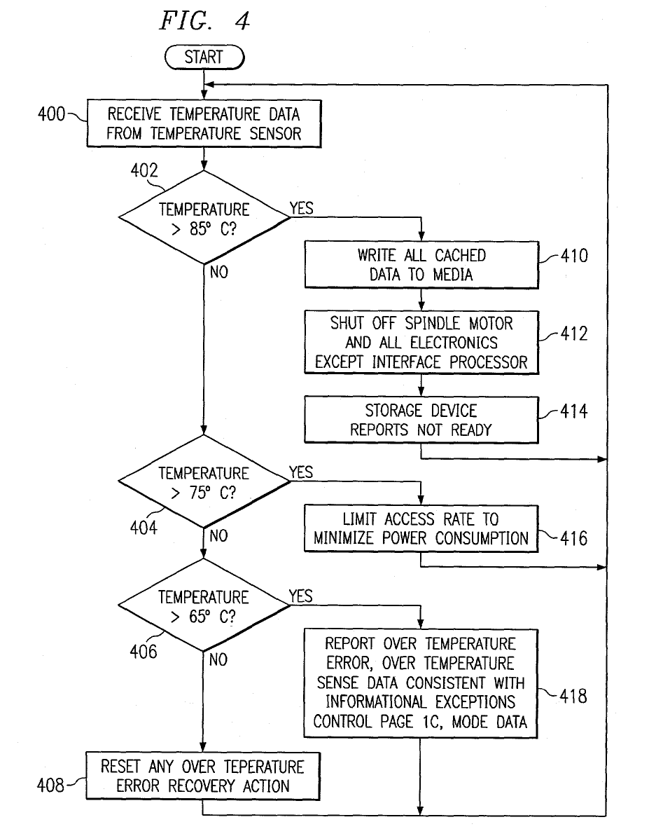

With reference now to FIG. 4, a flowchart of a process used to control the operation of a storage device is depicted in accordance with a preferred embodiment of the present invention. The process illustrated in FIG. 4 may be implemented in a processor, such as processor 302 within storage device 300 in FIG. 3.

The process begins by receiving temperature data from the temperature sensor (step 400). A determination is made as to whether the temperature is greater than 85° C. (step 402). If the temperature is not greater than 85° C., a determination is made as to whether the temperature is greater than 75° C. (step 404). If the temperature is not greater than 75° C., then a determination is made as to whether the temperature is greater than 65° C. (step 406). If the temperature is not greater than 65° C., any over temperature error recovery action is reset (step 408) and the process returns step 400. Step 408 is used to reset any actions that may have been taken previously in response to the temperature from the temperature data being above one of the other thresholds in steps 402, 404, or 406.

Returning again to step 406, if the temperature is greater than 65° C., a temperature error is reported and over temperature sensor data consistent with informational exceptions control page 1C, mode data (step 418) and the process returns to step 400. The informational exceptions control page defines the methods used by the target to control the reporting and the operations of specific informational exceptions conditions. SCSI mode page 1C may be used by the drive to implement the Self Monitoring Analysis and Reporting Technology (S.M.A.R.T.). The intention of S.M.A.R.T. is to recognize conditions that indicate imminent drive failure and to provide sufficient warning to the host system of impending failure. The mechanism of the present invention provides an extension to the S.M.A.R.T. technology by providing a mechanism for the device to take action to protect itself from an over temperature condition.

Referring again to step 404, if the temperature is greater than 75° C., the access rate is limited to minimize power consumption (step 416) with the process then returning to step 400 as described above.

With reference again to step 402, if the temperature is greater than 85° C., all cached data is written to media (step 410). Additionally, the spindle motor is shut off along with all electronics within the storage device except for the processor (step 412), and the storage device reports that it is not ready in response to all commands sent to it from the data processing system (step 414) with the process then returning to step 400 as described above.

Thus, the present invention provides an improved method, apparatus, and computer implemented instructions for managing operation of a storage device based on the temperature detected within the storage device. This mechanism performs different actions with respect to the operation of the storage device when different thresholds are reached or exceeded. Access rates may be reduced or the storage device may be essentially shut down depending on the temperature detected within the storage device.

In this manner, the mechanism of the present invention allows for a storage device to survive under conditions of excess temperature stress that normally cause the storage device to fail. This mechanism is useable for many different types of storage devices in which excess temperatures may cause reliability problems or device failures.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the mechanism of the present invention may be applied to other types of storage devices, such as a memory stick or flash memory. A temperature sensor may be included with an integrated circuit making up a memory stick or flash memory. Further, the mechanism of the present invention could be applied to storage subsystems containing multiple storage devices.

Although the examples illustrated three thresholds, other numbers of thresholds and threshold temperatures may be used depending on the particular implementation. Also, other actions may be taken, such as, for example, shutting down selected circuits or restricting the type of access to a read access and not a write access. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing a storage device, the method comprising:
monitoring an operating temperature in the storage device; and
responsive to the operating temperature exceeding a threshold temperature, altering operation of the storage device to reduce effects of the storage device operating when the operating temperature exceeds the threshold temperature.

2. The method of claim 1, wherein the threshold temperature is a first threshold temperature and further comprising:
responsive to the operating temperature exceeding a second threshold temperature, further altering operation of the storage device to reduce effects of the storage device operating when the operating temperature exceeds the second threshold temperature.

3. The method of claim 1, wherein the altering step comprises:
reducing a rate of access to the storage device to reduce effects of the storage device operating when the operating temperature exceeds the threshold temperature.

4. The method of claim 2, wherein the storage device is a hard disk drive and wherein the further altering step comprises:
shutting off a spindle motor for the hard disk drive.

5. The method of claim 1, wherein the storage device is one of a hard disk drive, tape drive, CD-ROM drive, or DVD-ROM drive.

6. The method of claim 1, wherein the storage device includes a processor and wherein the method is implemented in instructions executed by the processor.

7. A method for managing a storage device, the method comprising:
responsive to detecting a first temperature in the storage device exceeding a first threshold level, limiting access rates to the storage device; and
responsive to detecting a second temperature in the storage device exceeding a second threshold level, shutting off a motor in the storage device.

8. The method of claim 7 further comprising:
responsive to detecting a third temperature in the storage device exceeding a third threshold level, generating an indication of a temperature problem.

9. The method of claim 7, wherein the storage device is one of a hard disk drive, tape drive, CD-ROM drive, or DVD-ROM drive.

10. A storage device comprising:
a memory, wherein the memory includes a set of instructions;
a temperature sensor, wherein the temperature sensor detects a temperature within the storage device;
a motor, wherein the motor controls manipulation of a storage media;
a controller system connected to a motor, wherein the controller system controls operation of the motor and reading of data from the storage media; and
a processing unit connected to the memory, the temperature sensor, and the controller system, wherein the processing unit executes the set of instructions to monitor an operating temperature in the storage device; and alter operation of the controller system to reduce effects of the storage device operating when the operating temperature exceeds the threshold temperature in response to the operating temperature exceeding a threshold temperature.

11. The storage device of claim 10, wherein the processing unit alters the operation of the storage device by reducing an access rate to the storage media.

12. The storage device of claim 10, wherein the processing unit alters the operation of the storage device by shutting off the motor.

13. A data processing system for managing a storage device, the data processing system comprising:
monitoring means for monitoring an operating temperature in the storage device; and
altering means, responsive to the operating temperature exceeding a threshold temperature, for altering operation of the storage device to reduce effects of the storage device operating when the operating temperature exceeds the threshold temperature.

14. The data processing system of claim 13, wherein the threshold temperature is a first threshold temperature and wherein the altering means is a first altering means and further comprising:
second altering means, responsive to the operating temperature exceeding a second threshold temperature, for further altering operation of the storage device to reduce effects of the storage device operating when the operating temperature exceeds the second threshold temperature.

15. The data processing system of claim 13, wherein the altering means comprises:
reducing means for reducing a rate of access to the storage device to reduce effects of the storage device operating when the operating temperature exceeds the threshold temperature.

16. The data processing system of claim 14, wherein the storage device is a hard disk drive and wherein the further altering means comprises:
shutting means for shutting off a spindle motor for the hard disk drive.

17. The data processing system of claim 13, wherein the storage device is one of a hard disk drive, tape drive, CD-ROM drive, or DVD-ROM drive.

18. The data processing system of claim 13, wherein the storage device includes a processor and wherein the monitoring means and the altering means are implemented in instructions executed by the processor.

19. A data processing system for managing a storage device, the data processing system comprising:
limiting means, responsive to detecting a first temperature in the storage device exceeding a first threshold level, for limiting access rates to the storage device; and
shutting means, responsive to detecting a second temperature in the storage device exceeding a second threshold level, for shutting off a motor in the storage device.

20. The data processing system of claim 19 further comprising:
generating means, responsive to detecting a third temperature in the storage device exceeding a third threshold level, for generating an indication of a temperature problem.

21. The data processing system of claim 19, wherein the storage device is one of a hard disk drive, tape drive, CD-ROM drive, or DVD-ROM drive.

22. A computer program product in a computer readable medium for managing a storage device, the computer program product comprising:
first instructions for monitoring an operating temperature in the storage device; and
second instructions, responsive to the operating temperature exceeding a threshold temperature, for altering operation of the storage device to reduce effects of the storage device operating when the operating temperature exceeds the threshold temperature.

23. A method for managing a storage device, the method comprising:
first instructions, responsive to detecting a first temperature in the storage device exceeding a first threshold level, for limiting access rates to the storage device; and
second instructions, responsive to detecting a second temperature in the storage device exceeding a second threshold level, for shutting off a motor in the storage device.
